(19) United States
(12) Patent Application Publication
(10) Pub. No.: US 2003/0128205 A1
(43) Pub. Date: Jul. 10, 2003

(54) User interface for a three-dimensional browser with simultaneous two-dimensional display

(75) Inventor: Vibi Varghese, Englewood, CO (US)

Correspondence Address: Lee G Meyer, Meyer & Associates, 17462 E Powers Drive, Centennial, CO, 80015-3406, US

(73) Assignee: Code Beyond

(21) Appl. No.: 10/137,281

(22) Filed: Apr. 30, 2002

Related U.S. Application Data
(60) Provisional application No. 60/346,796, filed on Jan. 7, 2002.

(51) Int. Cl. G06T 15/00

(52) U.S. Cl. 345/419

(57) ABSTRACT

Methods, devices and systems for accessing information from a remote site, such as a computer located on a network, are disclosed. The method includes displaying a three-dimensional representation of the information from the remote site in a first area of a display device. The three-dimensional representation of information defines a virtual world populated with one or more objects of interest. The method also includes receiving one or more instructions from an input device for navigating the virtual world displayed in the first area of the display device and for selecting an object in the virtual world. Upon selecting an object in the first area of the display device, the method displays information about the object in a second area of the display device and displays a three-dimensional model of the selected object in a third area of the display device.

### CROSS-REFERENCE TO RELATED APPLICATION

This application claims the benefit of U.S. Provisional Application No. 60/346,796, filed Jan. 7, 2002.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates to navigation within a virtual three-dimensional environment and, in particular, to displaying data simultaneously using two-dimensional and three-dimensional representations of data.

2. Description of Related Art

The Internet is basically a network of various types of computers, connected over telecommunication lines, communicating with each other through a protocol known as Transmission Control Protocol/Internet Protocol (TCP/IP) for the purpose of exchanging information. Being “connected to the Internet” can mean anything from sending a simple message to a colleague across the state, to logging into another computer halfway around the world to search and retrieve text, graphics, sounds and even movies. Accessing the Internet requires a computer that has TCP/IP communication capabilities and is physically connected to the Internet with an identifiable Internet address.

Many Internet service providers, such as PRODIGY, AMERICA ON LINE, and AT&T, offer access to the Internet through their TCP/IP compatible UNIX computers already connected to the Internet. A subscriber to one of these service providers need only have a personal computer and a modem to make a telecommunication connection to the service provider's UNIX computer.

Various information exchanges on the Internet are available through functions such as electronic message exchange (E-mail) and File Transfer Protocol (FTP). Electronic mail is a service that allows two people to send messages to each other in a near real time manner. Messages can be sent to one address or multiple addresses. E-mail can also be used to retrieve documents from other computers on the Internet. File Transfer Protocol refers to moving files from one place to another on the Internet. The files may contain electronic documents, images, sounds, etc. Anything stored on the computer can be moved with FTP.

During the mid 1990s, a new mode of navigating the Internet called the World Wide Web (hereinafter “the Web”) has emerged which provides a hypertext interface to information on the Internet. The Web uses the client-server model of computer interaction, with the server being a computer on the Internet providing information, and the client being a computer retrieving the information.

Previously, the normal way to navigate the Internet was by moving through directory trees of information, whereby moving from node to node required providing an address for each node. In contrast, with the hypertext interface, information can be stored and retrieved in a non-hierarchical structure. In essence, one can “jump” from one place of information on the Internet to another through a series of “hypertext links” created by someone. A hypertext link can literally allow one to simply select a word, using a mouse or key command, and immediately be transported to another document on the Internet possibly halfway around the world.

In a hypertext interface, all the technical aspects of moving from one website to another website are hidden from the user, leaving the client free to explore without interference. Communication through the Web is by a HyperText Transport Protocol (HTTP), which uses a HyperText Markup Language (HTML). The HyperText Markup Language uses Uniform Resource Locators (URLs), which are a way of specifying the location of something on the Internet, to make the hypertext links.

Access to the Web requires a software tool typically referred to as a browser, which is installed on the client computer used to access the Internet. Browsers may be text based line browsers, or graphical based browsers such as MOSAIC, NETSCAPE, and INTERNET EXPLORER. These browsers are essentially HTML-based, two-dimensional web browsers that display Internet data as text and two-dimensional images. Using scripts, a web browser may also be enabled to display animation and three-dimensional data on a portion of its display area.

Other web browsers have adopted an even more graphical approach to a user interface, the three-dimensional virtual world interface. These non-HTML browsers, like the ACTIVEWORLDS browser currently available at http://www.activeworlds.com, for example, allow users to browse the Web by displaying a three-dimensional virtual world around which the user can navigate. The user generally selects an avatar, a computer representation of the user, and maneuvers the avatar through the three-dimensional virtual world. The user can also interact with the world and other users, so that browsing within the three-dimensional virtual world becomes an experience similar to playing a first-person point of view style video game, such as DOOM. Current three-dimensional browsers are useful for virtual chat rooms and for playing games, but due to their lack of substantial textual display, are of limited value for other applications.

For example, e-commerce applications allow consumers and providers of goods and services to transact business over the Internet. Since the consumers and providers of goods and services do not interact in person, such applications often include a substantial amount of textual data, which provide information about the goods and services and permits exchange of business information, including consumer addresses, credit card numbers, and the like. Thus, many e-commerce consumers opt for two-dimensional browsers to get the benefit of textual information and input, thereby sacrificing the intuitive user-friendly virtual reality-based aspect of three-dimensional browsing. Therefore, it would be desirable to provide a user interface that takes advantage of the benefits of both two-dimensional and three-dimensional browsers.

### SUMMARY OF THE INVENTION

The present invention provides a novel display paradigm useful in connection with examining and manipulating virtual objects, which are graphical or pictorial representations of tangible objects. According to one aspect of the present invention, a simultaneous two-dimensional and three-dimensional display shows representations of objects, group of objects, or virtual worlds of interest in the context of a web browser. The present invention may also be used to display local client data, or data from auxiliary memory, such as a diskette or CD-ROM. Another aspect of the present invention provides an integrated two- and three-dimensional browsing experience.

The present invention overcomes the limitations of prior art two-dimensional and three-dimensional browsers, discussed above, by providing the user two separate, yet linked, display areas, i.e. viewing areas, within the browser window. One of the display areas functions as a two-dimensional browser area, which may be an HTML enabled browser, similar in appearance to two-dimensional browsers such as NETSCAPE. The other display area functions as a three-dimensional virtual world browser area. To provide an integrated browsing experience, the two display areas are displayed simultaneously, and actions taken by the user in one display area affect the other display area.

Thus, the two display areas continuously correspond, thereby providing the user with information about the tangible objects of interest concurrently from two different perspectives. For example, the three-dimensional display area may show a virtual model of an object of interest which could be manipulated by the user, while the two-dimensional display area may contain textual information, such as dimensions, physical description, available options, availability, and other characteristics associated with the object. The two-dimensional display area may also have a photograph of the object. Furthermore, the two-dimensional area may also have input fields, or buttons that can spawn input screens for collecting user input.

Therefore, one aspect of the present invention provides a method for accessing information from a remote site, such as a computer located on a network. The method includes displaying a three-dimensional representation of the information from the remote site in a first area of a display device. The three-dimensional representation of information defines a virtual world populated with one or more objects of interest. The method also includes receiving one or more instructions from an input device for navigating the virtual world displayed in the first area of the display device and for selecting an object in the virtual world. Upon selecting an object in the first area of the display device, the method displays information about the object in a second area of the display device and displays a three-dimensional model of the selected object in a third area of the display device. The first and third areas may correspond to the same or different regions of the display device, whereas the first and second areas correspond, at least partially, to different regions of the display device.

Another aspect of the present invention provides a device for accessing information from a remote site, such as a computer located on a network. The device includes a software routine that is tangibly embodied on a computer-readable medium and is configured to simultaneously display three-dimensional and two-dimensional representations of the information in first and second areas of a display device, respectively. The three-dimensional representation defines a virtual world populated with one or more objects of interest and the two-dimensional representation provides textual information about the virtual world. The software routine is also configured to receive one or more instructions from an input device for navigating the virtual world displayed in the first area of the display device and for selecting one or more of the objects of interest. The selection of one of the objects of interest causes the software routine to display a three-dimensional model of the object in a third area of the display device, which may be the same as or different than the first area of the display device, and to display textual information about the object in the second area of the display.

Still another aspect of the present invention provides a system for accessing information from a remote site. The system includes a computer and a software routine that runs on the computer. The software routine is configured to simultaneously display three-dimensional and two-dimensional representations of the information in first and second areas of a display device, respectively. The three-dimensional representation defines a virtual world populated with one or more objects of interest and the two-dimensional representation provides textual information about the virtual world. The software routine is also adapted to receive one or more instructions from an input device for navigating the virtual world displayed in the first area of the display device and for selecting one or more of the objects of interest. The selection of one of the objects of interest causes the software routine to display a three-dimensional model of the object in a third area of the display device and to display textual information about the object in the second area of the display. The first and third areas may correspond to the same or different regions of the display device.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is an exemplary computer system on which the present invention may be practiced;

FIG. 2 is a screenshot of an exemplary department store website;

FIG. 3 is a screenshot of the exemplary department store website of FIG. 2 in which a user is positioned next to a first object in a first display area;

FIG. 4 is a screenshot following selection of the first object displayed in the first display area of FIG. 3;

FIG. 5 is a screenshot showing manipulation of the first object in the first display area;

FIG. 6 is a screenshot of the exemplary department store website after returning from the selection mode of FIG. 4 and FIG. 5;

FIG. 7 is a screenshot of the exemplary department store of FIG. 2 in which the user is positioned next to a second object in the first display area;

FIG. 8 is a screenshot following selection of the second object displayed in the first display area of FIG. 7;

FIG. 9 is a flowchart of a method for accessing information from a remote site, such as a website;

FIG. 10 and FIG. 11 are screenshots of a fashion-oriented application;

FIG. 12 and FIG. 13 are screenshots of a demonstration or trade show application;

FIG. 14 and FIG. 15 are screenshots of an interactive online encyclopedia;

FIG. 16 through FIG. 20 are screenshots of an interior decorating application.

### DETAILED DESCRIPTION

While the present invention has numerous applications and embodiments, for ease of understanding, it is described here in the context of an exemplary Business-to-Consumer (B2C) application for a department store website. The exemplary website may be used by e-commerce consumers to browse, research, manipulate, customize, assemble or purchase various products. Thus the following is a description of how a browser embodiment of the present invention would display the department store website, which has been enabled to receive and transmit information to the browser.

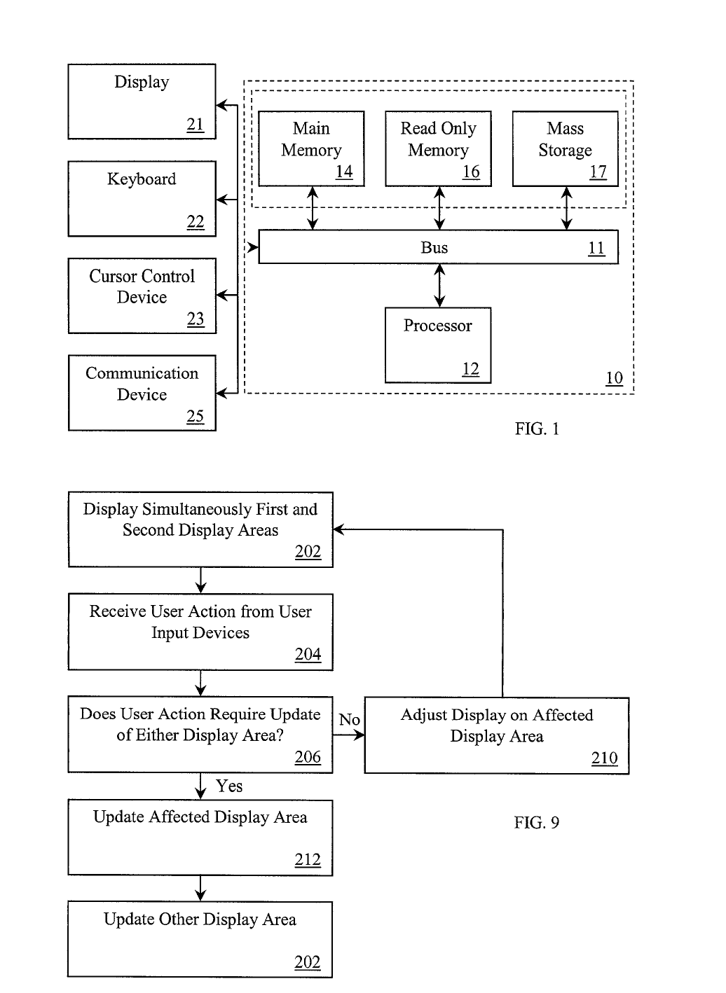

The present invention may be implemented in a computer system, such as the computer system 10, which is now described with reference to FIG. 1. Computer system 10 comprises a bus or other communication means 11 for communicating information, and a processing means such as processor 12 coupled with bus 11 for processing information. Computer system 10 further comprises a random access memory (RAM) or other dynamic storage device 14 (referred to as main memory), coupled to bus 11 for storing information and instructions to be executed by processor 12. Main memory 14 also may be used for storing temporary variables or other intermediate information during execution of instructions by processor 12. Embodiments of the present invention may be stored in main memory 14 as processor executable instructions. Computer system 10 also comprises a read only memory (ROM) and/or other static storage device 16 coupled to bus 11 for storing static information and instructions for processor 12. Embodiments of the present invention may also be stored in storage device 16 as processor executable instructions. A data storage device 17 such as a magnetic disk or optical disc and its corresponding drive may also be coupled to bus 11 for storing information and instructions.

Computer system 10 may also be coupled via bus 11 to a display device 21, such as a cathode ray tube (CRT) or Liquid Crystal Display (LCD), for displaying information to a computer user. The two- and three-dimensional display areas of the present invention may be displayed on display device 21. Typically, an alphanumeric input device 22, including alphanumeric and other keys, may be coupled to bus 11 for communicating information and/or command selections to processor 12. Another type of user input device is cursor control 23, such as a mouse, a trackball, a joystick, or cursor direction keys for communicating direction information and command selections to processor 12 and for controlling cursor movement on display 21.

A communication device 25 is also coupled to bus 11 for accessing remote servers or other servers via the Internet, for example. The communication device 25 may include a modem, a network interface card, or other well-known interface devices, such as those used for coupling to an Ethernet, token ring, or other types of networks. In any event, in this manner, the computer system 10 may be coupled to a number of clients and/or servers via a conventional network infrastructure, such as a company's Intranet and/or the Internet, for example. In one embodiment, the browser of the present invention accesses the exemplary department store website on the department store server via the Internet through communication device 25.

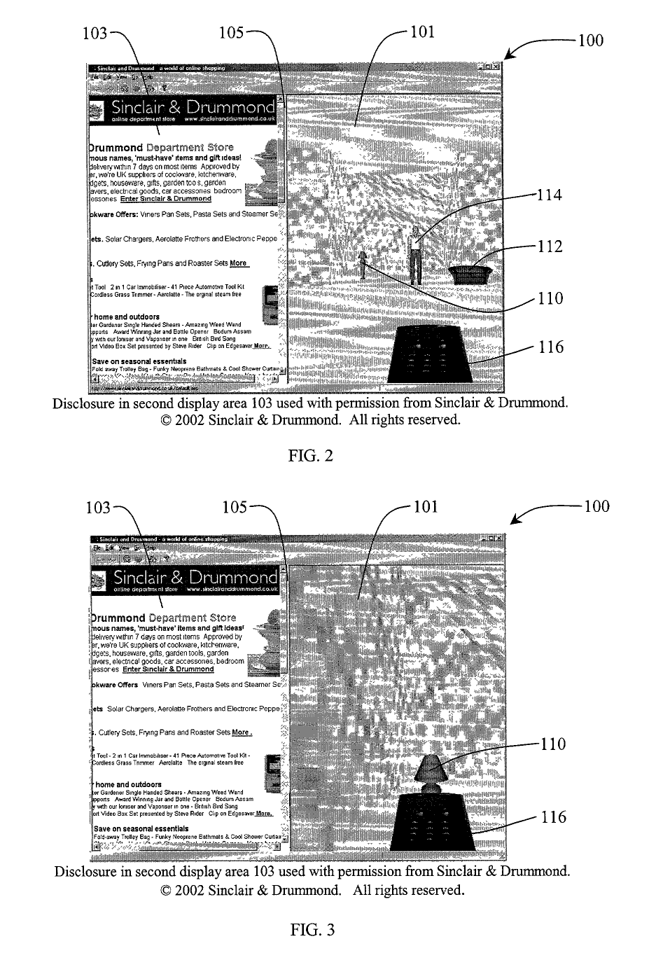

Referring now to FIG. 2, an exemplary department store website is shown, as it would be displayed by a browser according to one embodiment of the present invention, for example using display device 21. The browser window 100—where the window is an operating system invariant as exemplified by the MICROSOFT WINDOWS, MACINTOSH, and other operating systems utilizing a graphical user interface—is divided into two display areas: first display area 101 and second display area 103. The user may change the respective sizes of the display areas 101, 103 by, for example, dragging partition 105 with a mouse. Display areas 101, 103 need not be divided vertically; any division is possible. Furthermore, window 100 may contain other display areas in addition to the first display area 101 and the second display area 103.

Second display area 103 shows a two-dimensional browser area, which, in itself, could be similar to conventional two-dimensional browsers. Second display area 103 thus includes text, photographs, graphics or even animation, showing a virtual department store. First display area 101 shows a virtual world, three-dimensional browser area displaying a three-dimensional virtual world department store, which is visually navigable by the user. The virtual world department store includes first object 110 (a lamp), second object 112 (a couch), avatar 114 (a man), and pointer 116 (a remote control). Thus, the browser window 100 simultaneously displays the virtual department store in two- and thee-dimensions, so that the content of the two display areas is relationally linked. Of course, an actual virtual department store would contain many more objects representing items for sale. However, the drawings are kept simple in order not to confuse the figures and not to obscure the invention.

First object 110 is a three-dimensional representation of a lamp sold by the department store. As much as graphically possible, the store and its web site designers should aim to make first object 110, and all other displayed objects, representative of the physical objects represented and actually for sale in order to enhance the product research abilities of the customers. Similarly, second object 112 is a three-dimensional representation of a couch sold by the department store. Avatar 114 may represent another shopper or a customer service representative, i.e. a virtual store employee. In one embodiment, the browser of the present invention is enabled to communicate with avatar 114. In other embodiments, a store employee or an artificial intelligence algorithm that would simulate interaction with a store employee may control avatar 114.

Pointer 116 is a visual representation of the selection power, which the user may exercise regarding the objects and avatars in the virtual world. It provides a sense of presence in the three-dimensional environment. Pointer 116 is not an essential feature of the present invention. Therefore, it may be represented differently, or may be left out completely. In other embodiments, the view of the user may include the user's avatar, instead of the first-person point of view shown in FIG. 2, obviating the need for pointer 116.

The user may visually navigate through the virtual world shown in first display area 101 by using standard input controls, for example the alphanumeric input device 22 or the cursor control 23 in FIG. 1, which may include arrow keys on a keyboard, a mouse, a joystick, or similar input devices. Using these controls, the user can navigate to position his view of the virtual world so that the user would be positioned with first object 110 directly in front of the user, as shown in FIG. 3.

In FIG. 3, the browser of the present invention still shows first 101 and second 103 display areas in window 100 on display device 21. However, in FIG. 3 the user appears to be positioned directly next to first object 110. In one embodiment, the user selects an object for closer inspection, or an avatar for communication, by positioning himself directly next to the desired object or avatar, and then performing some selection action. Thus, in this embodiment, the selection action, which may be pressing a key on a keyboard or a button on a mouse or joystick, will only have the desired selection effect if the object of interest appears within a certain predetermined distance from the user in the virtual world. In one embodiment, this predetermined distance is the distance represented by the distance that the first object 110, the lamp, appears to be from the user of the browser in FIG. 3. Second display area 103 is unchanged from FIG. 2 to FIG. 3, since the user is still in the main shopping area of the virtual department store, and thus has not changed views from the virtual world mode. Therefore, second display area 103 corresponds to first display area 101 by continuing to display the main shopping area portion of the department store website.

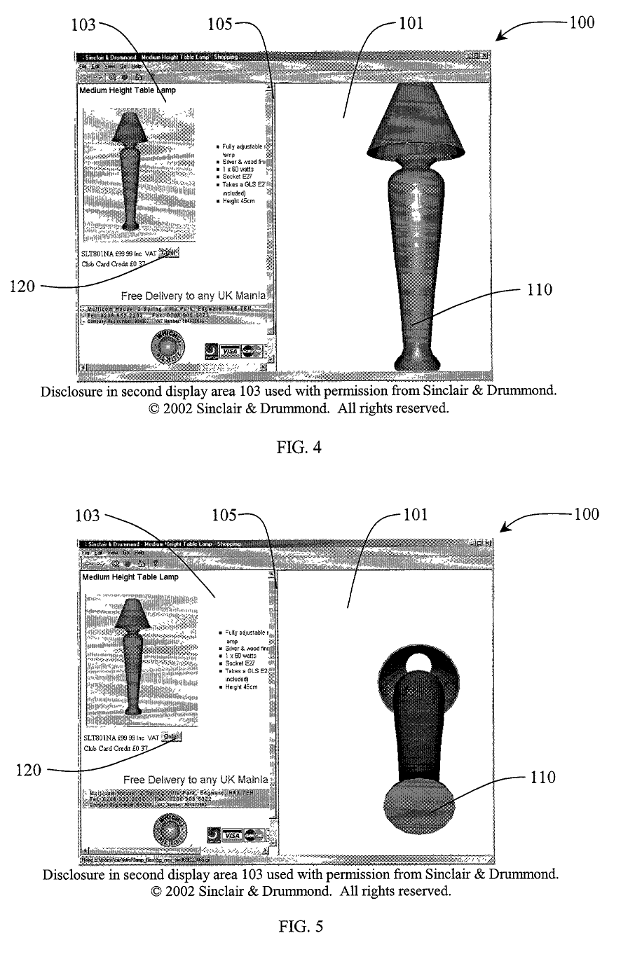

By performing the selection action with respect to first object 110, for example by clicking the mouse while being positioned in the virtual world as in FIG. 3, the user may select first object 110 for closer inspection. The browser, in response, will change its display as pictured in FIG. 4. In FIG. 4, the browser of the present invention still shows first 101 and second 103 display areas in window 100 on display device 21. However, in response to the user selection action, the selected first object 110, the lamp, is displayed exclusively and in detail in three dimensions, instead of the virtual world, in first display area 101. Thus, first display area 101 is now in selection mode, and no longer in virtual world mode. Without any further action taken by the user, the browser also updates second display area 103 in response to the user selection action and the change in viewing mode, to make it correspond with the selected first object 110. Therefore, second display area 103 in FIG. 4 shows a photograph of the lamp represented by first object 110 in the virtual world and textual information regarding first object 110.

In alternate embodiments, second display area 103 in FIG. 4 can also include an order button 120 which could activate an order screen in second display area 103. Alternatively, order input fields, such as credit card number information, could be displayed on the same display area 103 portion of the screen as the graphical and textual information regarding the selected object 10.

Furthermore, in one embodiment, the user can inspect the three-dimensional representation of first object 110 in first display area 101 of FIG. 4 by manipulating the object. This manipulation may include using some of the user control mechanisms discussed above, to rotate the selected object around a horizontal axis. Such rotation is illustrated by FIG. 5, which shows first object 10 being rotated. In other embodiments, the user may be able to also rotate first object 110 around other spatial axes, and the user may be able to customize first object 110 by changing its color, size, or other physical characteristics. Furthermore, the user may be able to view how a desired object would interact with other objects. For example, the user could select a table to go under the lamp.

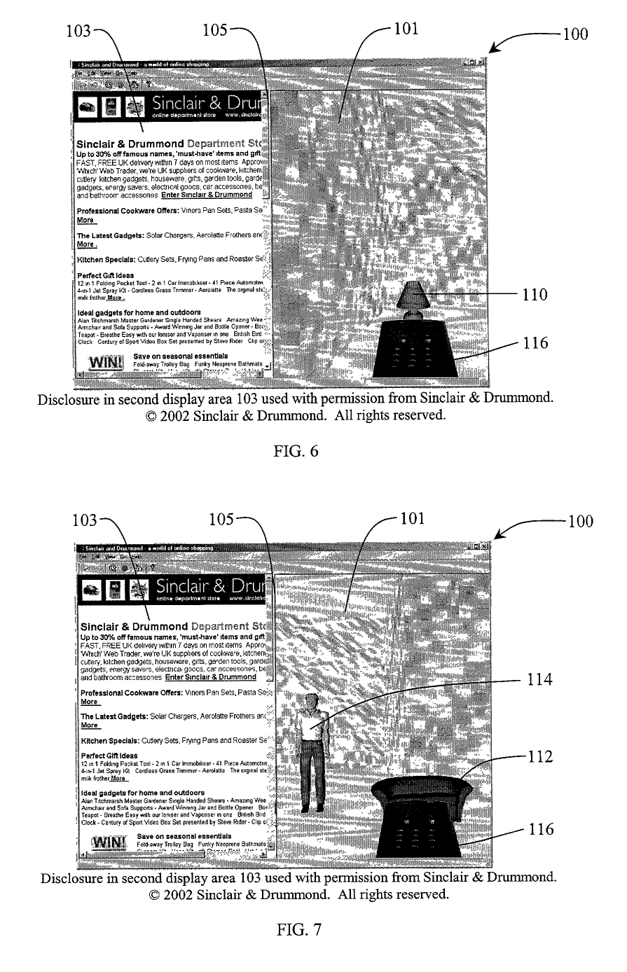

When the user is finished inspecting, manipulating, and reading about first object 110, the user may return to the virtual world department store by performing some escape action, which may comprise some user input such as pressing a key on a keyboard, or by using other input devices. Upon performing this escape action, the user would be switched back to virtual world mode from selection mode, and shown the same view in first display area 101 showing the virtual world department store as the user had when the user performed the selection action, as shown in FIG. 6. Alternatively, the user may be shown the entry view, as shown in FIG. 2. In other embodiments, user manipulations with respect to first object 110, such as color change, other physical manipulation, or association with other objects, may be reflected in the view of the user in first display area 101 after the escape action. For example, the lamp could now be blue and on top of a table. Without any further action by the user, second display area 103, in response to the escape action and the change in viewing mode also returns to the main department store website area, as shown in FIG. 6. Thus, first 101 and second 103 display areas continually correspond.

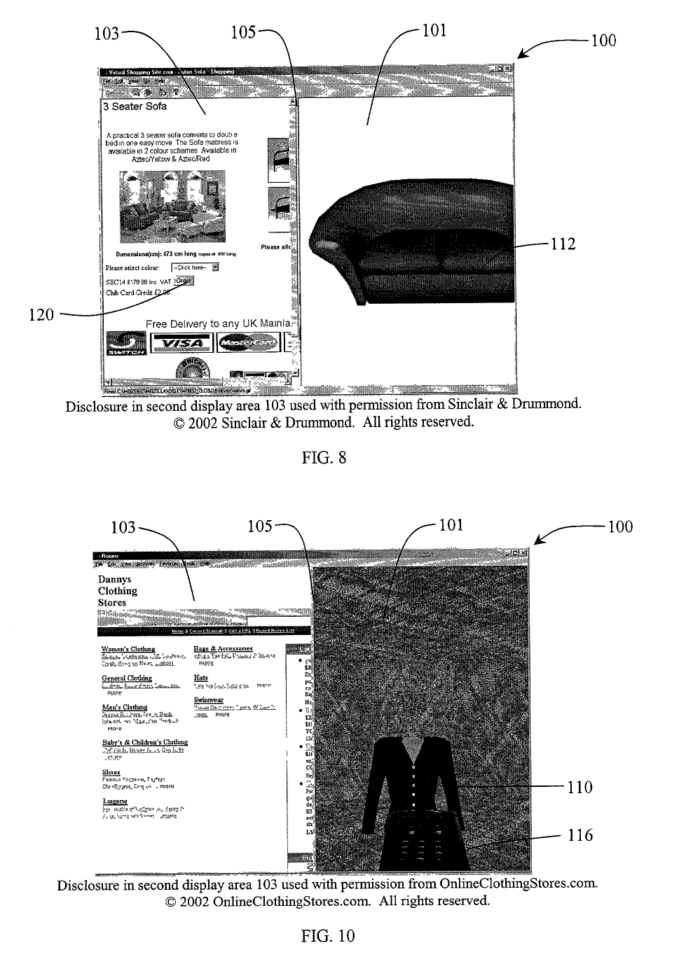

FIG. 7 and FIG. 8 again demonstrate how, in one embodiment, the user could navigate the virtual world to select another object, i.e., second object 112, for closer inspection and manipulation. Once again, in FIG. 7 and FIG. 8, first 101 and second 103 display areas continually correspond. When the user selects second object 112 in first display area 101 of FIG. 8, second display area 103 also changes to show information regarding the selected object 112. Similarly, upon entering selection mode in first display area 101, the second display area 103 likewise enters selection mode.

While, in the preferred embodiment it is the three-dimensional virtual world display area that controls the two-dimensional display area, in another embodiment, the user may take actions in two-dimensional second display area 103 that likewise would affect the virtual world in first display area 101. For example, the user may click on hyperlink 140 in FIG. 7, corresponding to text regarding “Cookware Offers.” While second display area 103 would display the web page associated with this hyperlink, first display area 101 could display a virtual world room containing only the items discussed on this web page. Alternatively, first display area 101 could display three-dimensional representations of the items referred to on the web page shown in second display area 103 from which the user could further select items, or scroll through these items using some user control mechanism.

FIG. 9 is a flow chart of a method 200 used by one embodiment of the browser of the present invention. In block 202, the browser simultaneously displays at least two related display areas, as explained above. Meanwhile, the browser, with the aid of computer system 10 (FIG. 1) on which it may be executing, is receiving user actions from the user input devices 204. Upon receiving a user action, the browser determines whether the user action is one, which entails a change in viewing mode, and thus necessitates an update of either one of the display areas 206. For example, clicking a hyperlink or selecting an object may necessitate a display area update, while visual navigation and three-dimensional object manipulation actions would not necessitate a display area update, merely an adjustment to one of the display areas, as explained above.

If no update or change in mode is required, for example because the action is an object manipulation, the browser performs the adjustments, if any, in the affected display area necessitated by the user action 210. Than, the browser again displays the two display areas 202 and waits for further user actions 204. However, if the user action received in block 204 is determined to necessitate a change in mode and an update of a display area in block 206, then the affected display area is updated 212 in response to the change in mode. To ensure that the two display areas continuously correspond, the other display area is also updated in response to the affected display area being updated 214, such that the other display area corresponds with the affected display area. In one embodiment, any user action affecting one display has a counterpart user action in the other user area having the same effect on that display as the original user action would after the updating. In the preferred embodiment, most of the user actions that entail a change in viewing mode and thus necessitate display area updates are taken with respect to the three-dimensional virtual world display area. After both display areas are updated, the browser once again displays the two display areas 202 and waits for further user actions 204.

General Matters

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps. The steps of the present invention may be performed by hardware components, or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media / machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

The present invention has been described above in the context of a web browser and illustrated with the specific example of how the web browser would display a department store website. First, in the embodiments of the present invention in which the display mechanism is a web browser, the browser can be used to access any enabled web site encompassing all the e-commerce applications presently available on the Internet, and those not yet in existence. Such e-commerce may include, but is not limited to Internet shopping, gaming, gambling, research, chat, dating, or entertainment. Some specific sample applications of the present invention may include a visual, three-dimensional encyclopedia, a medical application to assist in human anatomy visualization, an interior design application for selecting items to fill a room or rooms, a fashion application where clothes are assembled to co-ordinate.

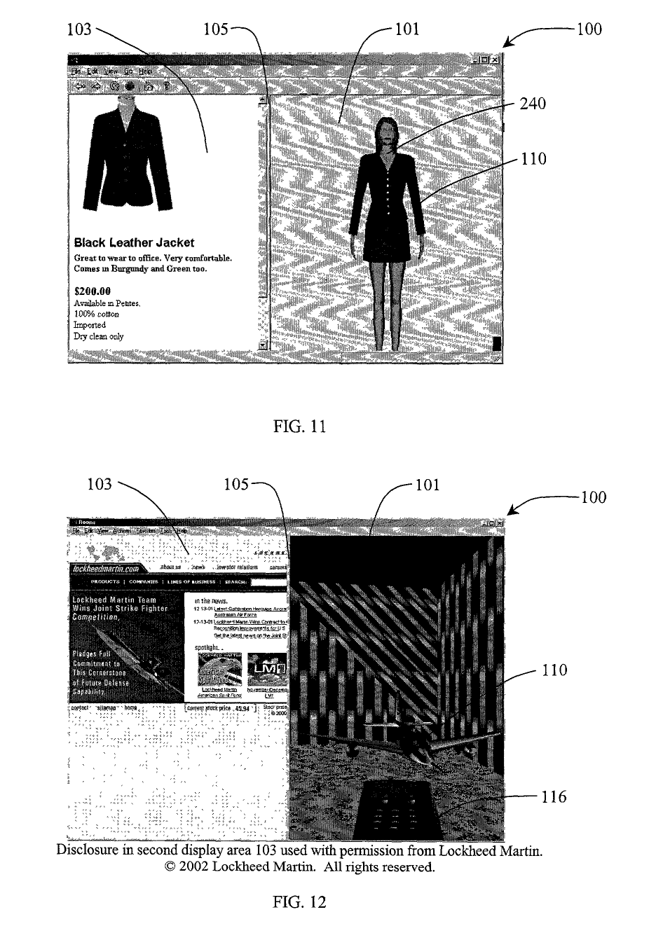

For example, FIG. 10 and FIG. 11 show screenshots of a fashion-oriented application in which selection of a first object 110 (i.e., jacket) in the first display area 101 of FIG. 10 results in the first object 110 being modeled by a virtual human FIG. 240 in the first display area 101 of FIG. 11. As can be seen in FIG. 11, textual and pictorial information (e.g., price, color, size, material, origin, care instructions, etc.) about the first object 110 is simultaneously displayed in the second display area 103.

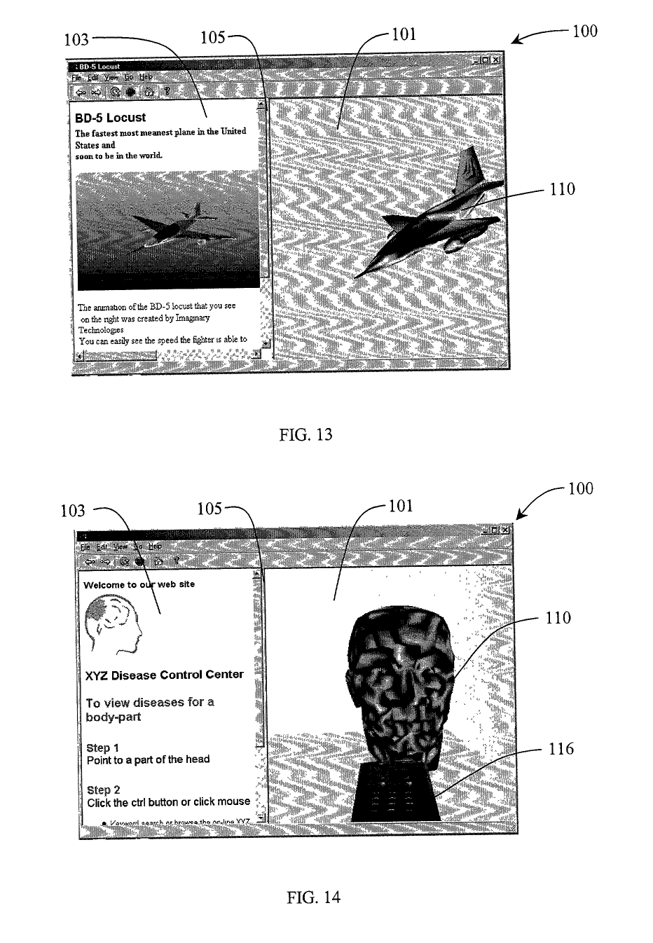

Similarly, FIG. 12 and FIG. 13 show screenshots of a demonstration or trade show application, in which selection of a first object 110 (i.e., an aircraft) results in display of a three-dimensional animation of the aircraft in the first display area 101. As shown in FIG. 13, textual and pictorial information about the aircraft is simultaneously displayed in the second display area 103.

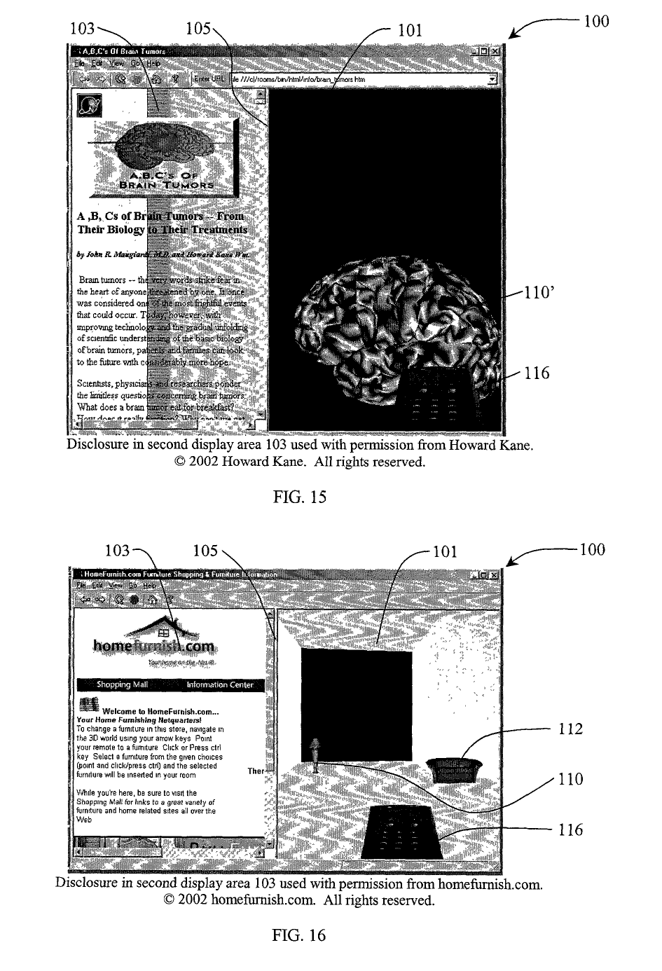

FIG. 14 and FIG. 15 show screenshots of an interactive online encyclopedia. As shown in FIG. 14, the second display area 103 provides instructions on how to access information about diseases of the brain. Selection of a first object 110 (i.e., a human head) in the first display area 101 of FIG. 14, results in a display of a three-dimensional model of a human brain 110′ in first display area 101 of FIG. 15 and in a simultaneous display of information about brain tumors in the second displayer area 103 of FIG. 15.

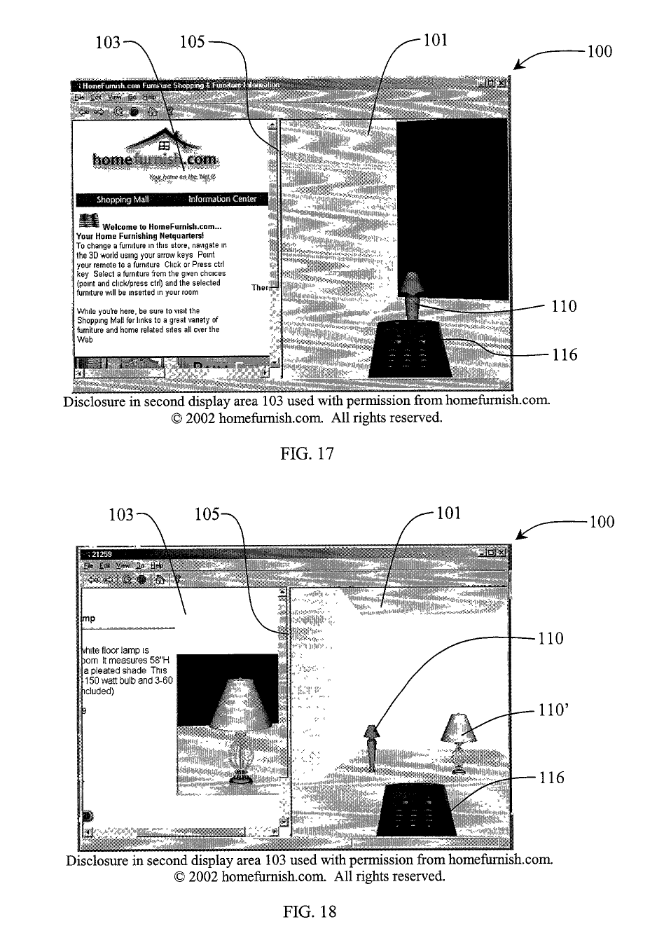

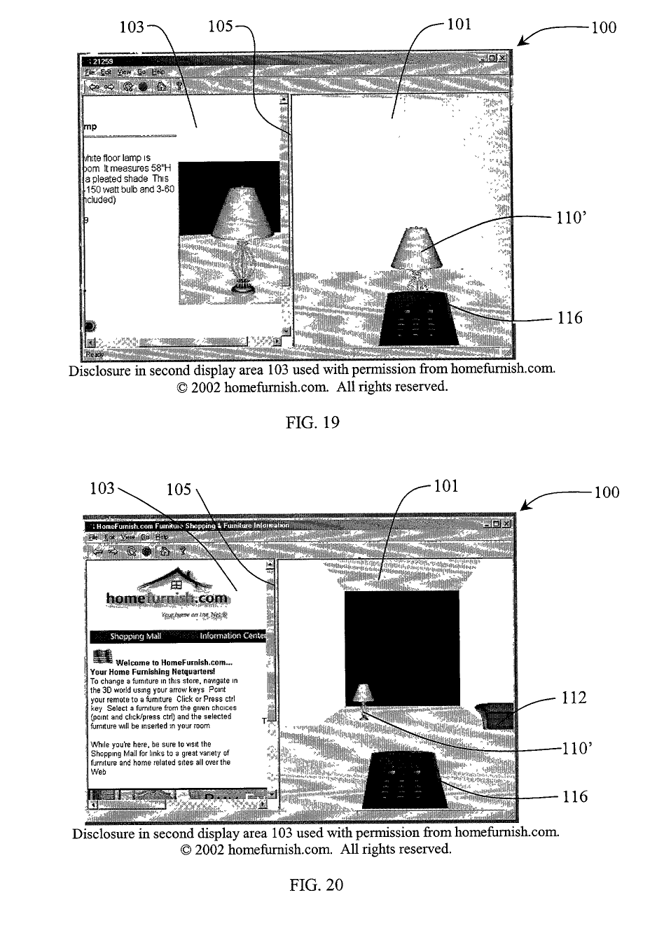

FIGS. 16-20 show a sequence of screenshots of an interior decorating application. The first display area 101 of FIG. 16 provides a virtual room for placement of various objects 110, 112, including accessories (a lamp) and furniture (chair). Using a mouse, keystrokes, etc., a user navigates within the virtual room until the user is located in front of the first object 110, as indicated by the position of a pointer 116 adjacent to the first object 110 in FIG. 17. The user selects the first object 110 by pressing a button on the mouse, by hitting a key on the keyboard, etc., which results in a simultaneous display of an alternative lamp 110′ in the first display area 101 of FIG. 18 and information about the alternative lamp 110′ in the second display area 103 of FIG. 18. To replace the first lamp 110 with the alternative lamp 110′, the user moves within the first display area 101 of FIG. 18 until the user is located in front of the alternative lamp 110′, as shown in FIG. 19. Upon selection of the alternative lamp 110′, the application displays the alternative lamp 110′ in the virtual room depicted in the first area 101 of FIG. 20.

The present invention is applicable to any present of future virtual reality-based application. Furthermore, the present invention is not limited to a web browser, but could be implemented as a display application for displaying information from any memory source, such as CD-ROMs. For example, a company could use the present invention to hand out virtual CD-ROM tours of a factory to new hires.

Many of the methods and functions of the present invention are described in their most basic form, but features can be added to or deleted from any of the functionalities and without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

What is claimed is:

1. A method for accessing information from a remote site, the method utilizing a local computer having a display device and an input device, the method comprising:
displaying a three-dimensional representation of information from the remote site in a first area of the display device, the three-dimensional representation of information defining a virtual world populated with one or more objects of interest;
receiving one or more instructions from the input device for navigating the virtual world displayed in the first area of the display device and for selecting an object in the virtual world;
displaying information about the object in a second area of the display device upon selecting the object in the first area of the display device, the first and second areas of the display device corresponding at least partially to different regions of the display device; and
displaying a three-dimensional model of the selected object in a third area of the display device.

2. The method of claim 1, wherein the first and third areas of the display device are the same.

3. The method of claim 1, further comprising receiving instructions from the input device for manipulating the selected object displayed in the third area of the display device.

4. The method of claim 3, wherein manipulating the selected object includes rotating the selected object.

5. The method of claim 3, wherein manipulating the selected object includes changing the size of the selected object.

6. The method of claim 1, further comprising displaying the object in an environment, the environment being different than the virtual world.

7. The method of claim 6, wherein the object represents an article of clothing and the environment includes a representation of a human being wearing the article of clothing.

8. The method of claim 1, further comprising displaying a three-dimensional animation of the selected object in the third area of the display device.

9. The method of claim 1, further comprising redisplaying the virtual world in the first area of the display device following the selection of the object.

10. The method of claim 9, wherein redisplaying the virtual world in the first area of the display device further includes updating the virtual world to include different objects.

11. The method of claim 9, further comprising updating the information in the second area of the display device upon redisplaying the virtual world.

12. The method of claim 1, further comprising displaying one or more action items in the second area of the display.

13. The method of claim 12, wherein one of the actions items corresponds to purchasing the object.

14. The method of claim 1, further comprising displaying one or more input fields in the second area of the display.

15. The method of claim 1, further comprising displaying information stored on the local computer.

16. The method of claim 1, wherein navigating comprises moving from one room to another room in the virtual world.

17. The method of claim 16, further comprising displaying information in the second area of the display device about one or more of the objects in the virtual world upon moving from one room to another room.

18. The method of claim 1, further comprising displaying a second object in the first area of the display device, the second objecting representing a user accessing information from the remote computer system.

19. A device for accessing information from a remote site, the device comprising a software routine tangibly embodied on a computer-readable medium and configured to simultaneously display three-dimensional and two dimensional representations of the information in first and second areas of a display device, respectively, the three-dimensional representation defining a virtual world populated with one or more objects of interest and the two-dimensional representation providing textual information about the virtual world;
the software routine also configured to receive one or more instructions from an input device for navigating the virtual world displayed in the first area of the display device and for selecting one or more of the objects of interest;
wherein selection of one of the objects of interest causes the software routine to display a three-dimensional model of the object in a third area of the display device, which may be the same as or different than the first area of the display device, and to display textual information about the object in the second area of the display.

20. A system for accessing information from a remote site, the system comprising a computer and a software routine running on the computer, the software routine configured to simultaneously display three-dimensional and two dimensional representations of the information in first and second areas of a display device, respectively, the three-dimensional representation defining a virtual world populated with one or more objects of interest and the two-dimensional representation providing textual information about the virtual world;
the software routine also configured to receive one or more instructions from an input device for navigating the virtual world displayed in the first area of the display device and for selecting one or more of the objects of interest;
wherein selection of one of the objects of interest causes the software routine to display a three-dimensional model of the object in a third area of the display device, which may be the same as or different than the first area of the display device, and to display textual information about the object in the second area of the display.
